(19) United States
(12) Patent Application Publication
(10) Pub. No.: US 2025/0132601 A1
(43) Pub. Date: Apr. 24, 2025

(54) APPARATUS CONFIGURED FOR BACKSCATTER MODULATION USING HARVESTED ENERGY

(71) Applicant: Nokia Technologies Oy, Espoo (FI)

(72) Inventors: Simon SVENDSEN, Aalborg (DK); Johannes HARREBEK, Aalborg (DK); Nuno Manuel KIILERICH PRATAS, Aalborg (DK); Oana-Elena BARBU, Aalborg (DK); Benny VEJLGAARD, Aalborg (DK)

(21) Appl. No.: 18/915,019

(22) Filed: Oct. 14, 2024

(30) Foreign Application Priority Data
Oct. 24, 2023 (GB) 2316223.3

(51) Int. Cl. H02J 50/00; H02J 50/27; H02J 50/40

(52) U.S. Cl. CPC H02J 50/001; H02J 50/27; H02J 50/40

(57) ABSTRACT

An apparatus comprising:
energy harvesting circuitry;
backscatter modulation circuitry powered at least partially using energy provided by the energy harvesting circuitry;
a first antenna element coupled via a first feed to the backscatter modulation circuitry; and
a second antenna element coupled via a second feed to the energy harvesting circuitry,
wherein the apparatus is configured to receive radio signals simultaneously, at the same frequency, at the backscatter modulation circuitry via the first antenna element and at the energy harvesting circuitry via the second antenna element.

### TECHNOLOGICAL FIELD

Examples of the disclosure relate to an apparatus configured for backscatter modulation using harvested energy.

### BACKGROUND

It is desirable to have apparatus that can perform backscatter modulation using energy provided by the energy harvesting. Backscatter modulation involves modulation of reflection of incident transmitted radio waves it can be achieved by time-variable control of a backscattering impedance. Energy harvesting involves capturing or harvesting energy wirelessly from an external source.

### BRIEF SUMMARY

According to various, but not necessarily all, examples there is provided an apparatus comprising:
energy harvesting circuitry;
backscatter modulation circuitry powered at least partially using energy provided by the energy harvesting circuitry;
a first antenna element coupled via a first feed to the backscatter modulation circuitry; and
a second antenna element coupled via a second feed to the energy harvesting circuitry,
wherein the apparatus is configured to receive radio signals simultaneously, at the same frequency, at the backscatter modulation circuitry via the first antenna element and at the energy harvesting circuitry via the second antenna element.

In some but not necessarily all examples, the backscatter modulation circuitry is configured to backscatter radio frequency waves of a first frequency incident on the first antenna and the energy harvesting circuitry is configured to harvest energy from radio frequency waves of the first frequency incident on the second antenna,

wherein the backscatter modulation circuitry is configured to backscatter radio frequency waves of the first frequency incident on the first antenna simultaneously with energy harvesting from radio frequency waves of the first frequency incident on the second antenna by the energy harvesting circuitry,

wherein the energy harvesting circuitry is configured to harvest energy from radio frequency waves of the first frequency incident on the second antenna simultaneously with backscatter of radio frequency waves of the first frequency incident on the first antenna by the backscatter modulation circuitry.

In some but not necessarily all examples, the backscatter modulation circuitry is configured to backscatter radio frequency waves incident on the first antenna but not the second antenna and the energy harvesting circuitry is configured to harvest energy from radio frequency waves incident on the second antenna but not the first antenna.

In some but not necessarily all examples, the first antenna element is distinct from the second antenna element and the first feed is distinct from the second feed.

In some but not necessarily all examples, the apparatus comprises one or more electrical isolation elements coupled between the first antenna element and the second antenna element.

In some but not necessarily all examples, the first feed is located adjacent a second portion of the first antenna element and the second feed is located adjacent a second portion of the second antenna element, wherein the second portion of the first antenna element and the second portion of the second antenna element are the most distant respective portions of the first antenna element and the second antenna element.

In some but not necessarily all examples, the first feed comprises a capacitive feed element separated from the second part of the first antenna element and wherein the second feed comprises a capacitive feed element separated from the second part of the second antenna element.

In some but not necessarily all examples, the first antenna element extends from a first part of the first antenna element to a second part of the first antenna element in a first direction within a first plane parallel to a ground plane and wherein the second antenna element extends from a first part of the second antenna element to a second part of the second antenna element in a second direction within a second plane parallel to the ground plane, wherein the first plane and the second plane are co-planar and the first direction and the second direction are opposing directions.

In some but not necessarily all examples, the first antenna element has a first length between the first part of the first antenna element and the second part of the first antenna element and the second antenna element has a second length between the first part of the second antenna element and the second part of the second antenna element wherein the first length and the second length are the same.

In some but not necessarily all examples, the apparatus comprises a first grounding element separated from the first antenna element, a second grounding element separated from the second antenna element, a first inductance connected between the first grounding element and the first antenna element and a second inductance connected between the second grounding element and the second antenna element.

In some but not necessarily all examples, the first grounding element extends from a ground plane and the second grounding element extends from the ground plane.

In some but not necessarily all examples, the backscatter modulation circuitry is configured to switch between multiple different impedance states to vary backscatter reflection over time.

In some but not necessarily all examples, the apparatus comprises a single pole N throw switch, wherein the backscatter modulation circuitry is configured to switch between N different impedance states using the single pole N throw switch.

In some but not necessarily all examples, the backscatter circuitry is configured to provide binary phase shift keying.

In some but not necessarily all examples, the apparatus is a passive radio and the received radio signals comprise activation signals of the passive radio.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

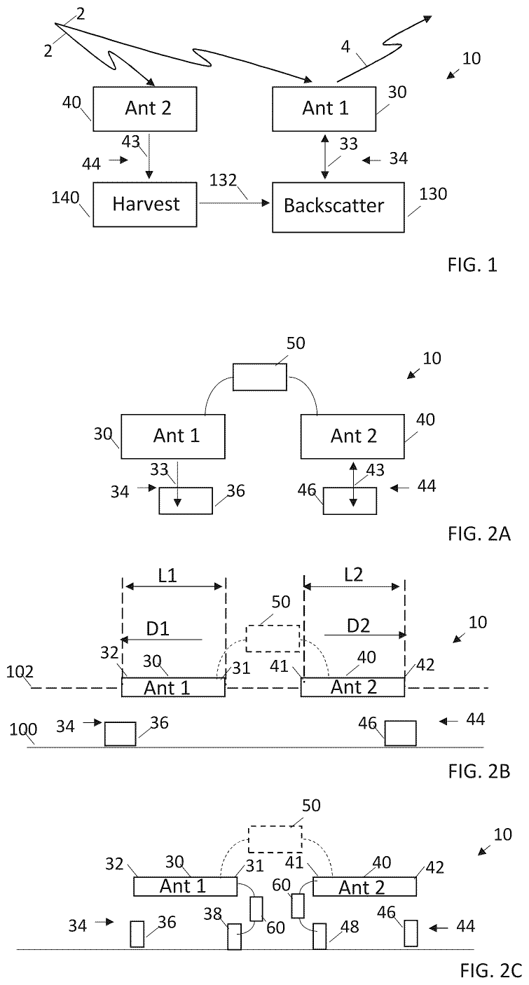

FIG. 1 shows an example of the subject matter described herein;

FIG. 2A shows another example of the subject matter described herein;

FIG. 2B shows another example of the subject matter described herein;

FIG. 2C shows another example of the subject matter described herein;

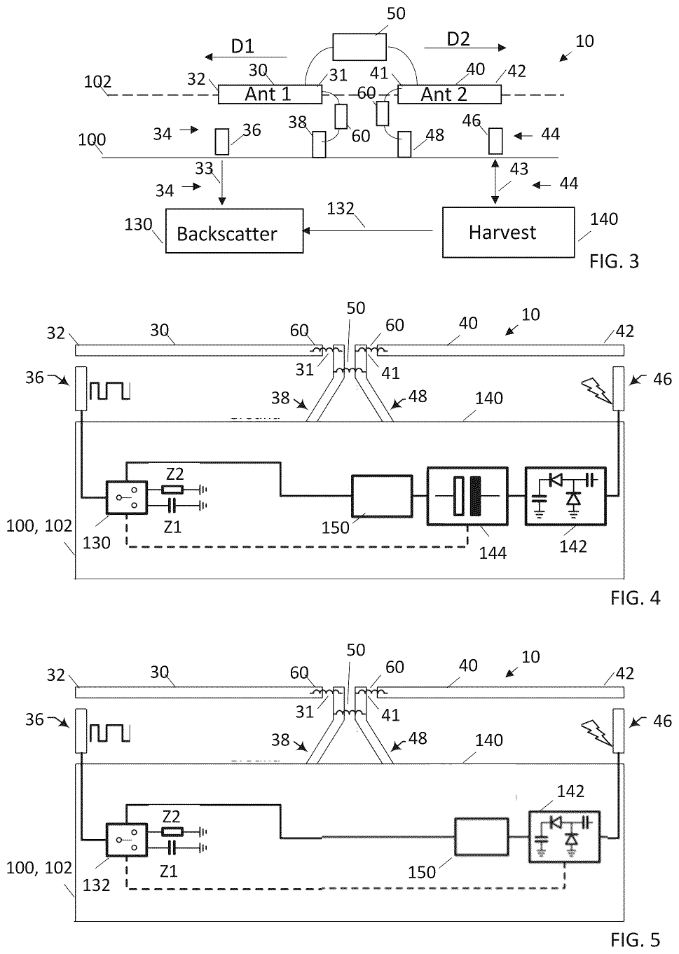

FIG. 3 shows another example of the subject matter described herein;

FIG. 4 shows another example of the subject matter described herein;

FIG. 5 shows another example of the subject matter described herein;

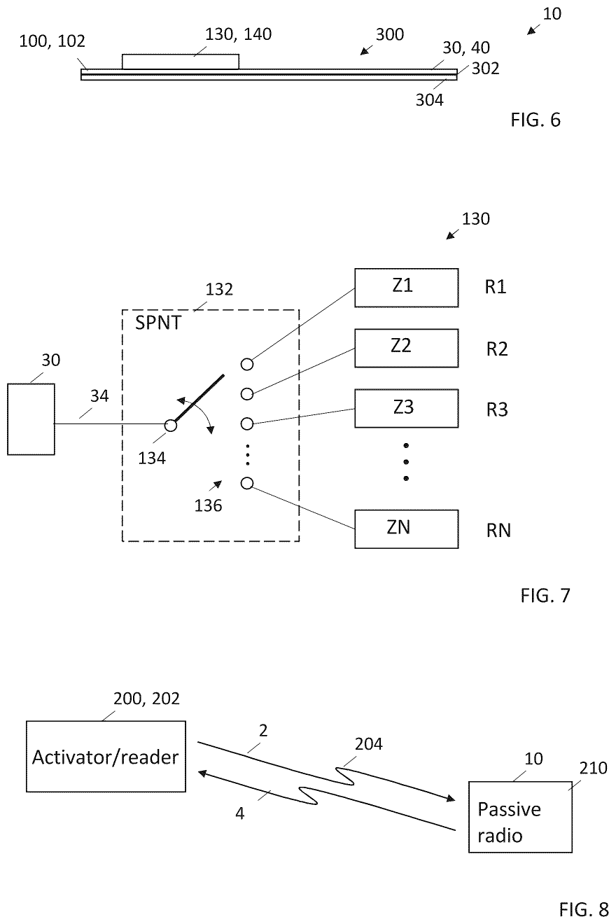

FIG. 6 shows another example of the subject matter described herein;

FIG. 7 shows another example of the subject matter described herein;

FIG. 8 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### Definitions

“backscatter”: is used to refer to the controlled reflection of incident transmitted radio waves. The radio waves are deliberately backscattered (reflected) using a backscattering impedance.

“backscatter modulation”: is used to refer to the modulation of reflection of incident transmitted radio waves. Modulation is achieved by time-variable control of the all backscattering impedance.

“phase shift keying” is a modulation approach that uses defined points in phase space to represent different information. For example, binary phase shift keying uses two defined points in phase space. Maximum efficiency is achieved if the defined points have maximal separation. Binary phase shift keying typically introduces a phase difference of π radians.

“energy harvesting” in this document means capturing or harvesting energy wirelessly from an external source. For example from incident transmitted radio waves within a defined bandwidth. For a passive radio, the incident transmitted radio waves could be wholly or partly from an activation signal for the passive radio.

“passive radio” means circuitry that returns or reflects radio signals by backscattering modulation or otherwise, in response to reception of activation radio signals addressed to the passive radio or a group of passive radios.

“passive radio tag” is a passive radio configured as a tag. The term ‘tag’ indicates that the passive radio is attached or of size suitable for being attached to another object. The passive radio and the passive radio tag have small form factors.

“ambient” as applied to a passive radio means an ambient power-enabled passive radio. An ambient power-enabled passive radio is a passive radio powered by energy harvesting. An ambient power-enabled passive radio can be battery-less or with limited energy storage capability (e.g., using a capacitor or supercapacitor).

“ambient internet of things (AIoT) device” describes an ambient power-enabled Internet of Things device. It is an IoT device powered by energy harvesting, being either battery-less or with limited energy storage capability (e.g., energy storage using a capacitor or supercapacitor). An AIoT device of Class A is battery-less and uses contemporaneous energy harvesting for operation. An AIoT device of Class B is battery-less and can use contemporaneous energy harvesting and/or previously stored harvested energy for operation.

The apparatus 10 described below is configured to perform backscatter modulation, optionally using phase shift keying. The apparatus 10 described is configured to perform energy harvesting. In some examples, the apparatus 10 is a passive radio or a passive radio tag. In some examples, the apparatus 10 is an ambient passive radio or an ambient passive radio tag. In some examples, the apparatus 10 is additionally or alternatively an AIoT device. In some examples the AIoT device is a Class A AIoT device. In some examples the AIoT device is a Class B AIoT device.

### DETAILED DESCRIPTION

The following figures illustrate different examples of an apparatus 10 comprising: energy harvesting circuitry 140; backscatter modulation circuitry 130 powered at least partially using energy 132 provided by the energy harvesting circuitry 140; a first antenna element 30 coupled via a first feed 34 to the backscatter modulation circuitry 130; and a second antenna element 40 coupled via a second feed 44 to the energy harvesting circuitry 140, wherein the apparatus 10 is configured to receive radio signals 33, 43 simultaneously, at the same frequency, at the backscatter modulation circuitry 130 via the first antenna element 30 and at the energy harvesting circuitry 140 via the second antenna element 40.

The backscatter modulation circuitry 130 modulates (varies with respect to time) backscattering of radio waves 2 incident upon the first antenna element 30. The radio waves are deliberately backscattered (reflected) using a backscattering impedance. Varying the backscattering impedance modifies backscattering (reflection).

The energy harvesting circuitry 140 extracts energy from the radio waves 2 incident upon the second antenna element 40. The apparatus 10 is powered by energy harvesting performed by the energy harvesting circuitry 140.

In at least some examples, the apparatus 10 is battery-less. In at least some examples, the apparatus 10 has a capacitance-based energy storage capability (e.g., using a capacitor or supercapacitor).

In at least some examples, the apparatus 10 is configured to use contemporaneous energy harvesting for operation. In at least some examples, the apparatus 10 is configured to use only contemporaneous energy harvesting for operation. In at least some examples, the apparatus 10 is configured to use previously stored harvested energy for operation. In at least some examples, the apparatus 10 is configured to use contemporaneous energy harvesting and/or previously stored harvested energy for operation.

In the example illustrated in FIG. 1, the apparatus 10 comprises: the energy harvesting circuitry 140; the backscatter modulation circuitry 130; the first antenna element 30 and the second antenna element 40.

The backscatter modulation circuitry 130 is powered at least partially using energy 132 provided by the energy harvesting circuitry 140. Depending on design this can be contemporaneously harvested energy, previously harvested energy or contemporaneously harvested and/or previously harvested energy.

The first antenna element 30 is coupled via the first feed 34 to the backscatter modulation circuitry 130. The second antenna element 40 is coupled via the second feed 44 to the energy harvesting circuitry 140.

The apparatus 10 is configured to simultaneously receive radio frequency waves 2 at the same frequency at the first antenna element 30 and the second antenna element 30. This provides radio signals 33, 43 simultaneously, at the same frequency, at the backscatter modulation circuitry 130 via the first antenna element 30 and at the energy harvesting circuitry 140 via the second antenna element 40. A first radio signal 33 is provided to the backscatter modulation circuitry 130 via the first antenna element 30. A second radio signal 43 is provided to the energy harvesting circuitry 140 via the second antenna element 40.

In this example, the backscatter modulation circuitry 130 is configured to backscatter radio frequency waves 2 of a first frequency incident on the first antenna element 30 and the energy harvesting circuitry 140 is configured to harvest energy from radio frequency waves 2 of the first frequency incident on the second antenna element 40. The backscattered radio frequency waves 4 are of the first frequency. In some examples, a phase of the backscattered radio frequency waves 4 is modulated.

The backscatter modulation circuitry 130 is configured to backscatter radio frequency waves 2 of the first frequency incident on the first antenna element 30 simultaneously with energy harvesting, by the energy harvesting circuitry 140, from radio frequency waves 2 of the first frequency incident on the second antenna element 40.

The energy harvesting circuitry 140 is configured to harvest energy 132 from radio frequency waves 2 of the first frequency incident on the second antenna element 40 simultaneously with backscattering, by the backscatter modulation circuitry 130, of radio frequency waves 2 of the first frequency incident on the first antenna element 30.

In at least some examples, the backscatter modulation circuitry 130 is configured to backscatter radio frequency waves 2 incident on the first antenna element 30 but not the second antenna element 40 and the energy harvesting circuitry 140 is configured to harvest energy 132 from radio frequency waves 2 incident on the second antenna element 40 but not the first antenna element 30.

In some examples, the backscatter modulation circuitry 130 is configured to only backscatter radio frequency waves 2 incident on the first antenna element 30. In some examples, the energy harvesting circuitry 140 is configured to only harvest energy from radio frequency waves 2 incident on the second antenna element 40.

In some examples, the energy harvesting circuitry 140 is configured to continuously, without interruption, harvest energy from radio frequency waves 2 incident on the second antenna element 40.

In the illustrated example, the first antenna element 30 is distinct from the second antenna element 40 and the first feed 34 is distinct from the second feed 44. The separation of backscatter modulation and energy harvesting allows high coverage and low charging resource overhead as backscatter modulation and energy harvesting can occur simultaneously.

A feed provides a radio frequency link between the antenna radiator and the relevant circuitry for conveying radio frequency signals in either direction (transmission and/or reception).

FIG. 2A illustrates an example of any of the apparatus 10 as previously described. In this example, the apparatus 10 comprises one or more electrical isolation elements 50 coupled between the first antenna element 30 and the second antenna element 40.

The one or more electrical isolation elements 50 improves electrical isolation between the first antenna element 30 and the second antenna element 40 at the first frequency.

The electrical isolation, for example as measured using the S-parameter S12 and the S-parameter S21, between the first antenna element 30 and the second antenna element 40 at the first frequency is greater (more isolation) when the one or more electrical isolation elements 50 are present than if they are absent.

The one or more electrical isolation elements 50 can, for example provide broadband isolation that includes the first frequency.

The one or more electrical isolation elements 50 can, for example, be one or more discrete components. The one or more electrical isolation elements 50 can, for example, be one or more impedances. The one or more electrical isolation elements 50 can, for example, be one or more reactive elements. The one or more electrical isolation elements 50 can, for example, be configured to provide predominantly an inductive impedance between the first antenna element 30 and the second antenna element 40.

The one or more electrical isolation elements 50 can, for example, be one or more lumped components. The one or more lumped components can have a desired electrical impedance. The electrical impedance can comprise a reactive component and/or a resistive component. The reactive component can comprise a capacitive component and/or an inductive component.

The one or more electrical isolation elements 50 can, for example, be one or more inductances. An inductance can be provided by a lumped inductance or lumped inductor, or a distributed inductive component such as a transmission line, a stub (transmission line connected at one end only), planar conductive elements etc.

The distributed inductive component can be made using printed circuit boards (PCB) technology to form the inductive reactance.

Other examples of distributed components include: microstrip lines, striplines, coplanar waveguides, planar spiral inductors, slotlines, stubs, etc. Distributed components are often designed with copper tracks and often employ a radio frequency ground plane.

A lumped component refers to a space efficient component which can be picked and placed by a robot onto a PCB and then soldered. They are normally purchased from a component manufacturer. A lumped component is typically smaller than a wavelength of the operational frequencies, and can be less than 1/20 of a wavelength. For example, the largest dimension of a lumped component can be a few mm or less.

The electrical isolation enables a backscattering impedance change for the first antenna element 30 without affecting the energy harvesting impedance match for the second antenna element 40.

FIG. 2B illustrates an example of any of the apparatus 10 as previously described. In this example, the first antenna element 30 extends in a first direction D1 from a first portion 31 to a second portion 32 within a plane 102. The first antenna element 30 extends for a length L1 between the first portion 31 and the second portion 32.

In this example, the second antenna element 40 extends in a second direction D2 from a first portion 41 to a second portion 42 within the plane 102. The second antenna element 40 extends for a length L2 between the first portion 41 and the second portion 42.

The plane 102 can be into the plane of the page or perpendicular to the plane of the page.

In at least some embodiments, the first length L1 and the second length L2 are the same.

In at least some embodiments, the first direction D1 and the second direction D2 are opposing directions. In at least some embodiments, the first direction D1 and the second direction D2 are opposing directions and are aligned i.e., the first and second antenna elements 30, 40 are aligned.

In this example, the first portion 31 of the first antenna element 30 and the first portion 41 of the second antenna element 40 are the closest (minimum separation) respective portions of the first antenna element 30 and the second antenna element 40.

In this example, the second portion 32 of the first antenna element 30 and the second portion 42 of the second antenna element 40 are the most distant (maximum separation) respective portions of the first antenna element 30 and the second antenna element 40.

The first feed 34 for the first antenna element 30 is located adjacent the second portion 32 of the first antenna element 30. The second feed 44 for the second antenna element 40 is located adjacent the second portion 42 of the second antenna element 40.

In this example, but not necessarily all examples, the first feed 34 is an indirect feed (not galvanic) and the second feed 44 is an indirect feed (not galvanic). The first feed 34 comprises a first capacitive feed element 36 physically separated from the second part 32 of the first antenna element 30 by a dielectric gap and the second feed 44 comprises a capacitive feed element 46 separated from the second part 42 of the second antenna element 40 by a dielectric gap. The dielectric gap comprises dielectric, for example air or a dielectric material.

In this example, but not necessarily all examples, the plane 102 is parallel to a ground plane 100. Where the plane 102 is into the plane of the page, the plane 102 and the ground plane 100 are separated. Where the plane 102 is parallel to the plane of the page, the plane 102 and the ground plane 100 are co-planar (see FIGS. 4 & 5). In some but not necessarily all examples (see FIGS. 4 & 5) the plane 102 comprising the first and second antenna elements is co-planar with the ground plane 100.

Although in this example, first antenna element 30 and the second antenna element 40 are co-planar in other examples the first antenna element 30 and the second antenna element 40 are on different planes with different distances to ground plane 100. The different planes may or may not be parallel. Other arrangements of ground plane(s) and antenna radiator(s) can be used, with one or more co-planar portions and one or more non-co-planar portions, including curved or bent portions.

FIG. 2C illustrates an example of any of the apparatus 10 as previously described. The apparatus 10 comprises a first grounding element 38 separated from the first antenna element 30 and a second grounding element 48 separated from the second antenna element 40.

The first grounding element 38 extends from a ground plane 100 towards the first antenna element 30 (not the second antenna element 40) and, the illustrated example, is separated from the first antenna element 30 by a small gap. The second grounding element 48 extends from the ground plane 100 towards the second antenna element 40 (not the first antenna element 30) and, in the illustrated example, is separated from the second antenna element 40 by a small gap.

In this example, but not necessarily all examples, a first inductance 60 is connected between the first grounding element 38 and the first antenna element 30 across the gap between the first grounding element 38 and the first antenna element 30. In this example, but not necessarily all examples, a second inductance 60 is connected between the second grounding element 48 and the second antenna element 40 across the gap between the second grounding element 48 and the second antenna element 40.

In some examples (not illustrated), the first grounding element 38 and the first antenna element 30 interconnect and there is no gap between the first grounding element 38 and the first antenna element 30 nor any first inductance 60. In some examples (not illustrated), the second grounding element 48 and the second antenna element 40 interconnect and there is no gap between the second grounding element 48 and the second antenna element 40 nor any second inductance 60.

The first inductance 60 can, for example, be used to extend an electrical length of the first antenna element 30 and the second inductance 60 can, for example, be used to extend an electrical length of the second antenna element 40.

In some examples, the inductance of the first inductance 60 and the inductance of the second inductance 60 is the same.

The combination of first feed 34, first capacitive feed element 36, first antenna element 30, first grounding element 38 and the ground plane 100 creates a first current loop. This can provide loop antenna characteristics.

The combination of second feed 44, second capacitive feed element 46, second antenna element 40, second grounding element 48 and the ground plane 100 creates a second current loop. This can provide loop antenna characteristics.

It should be appreciated that the one or more inductances 50 coupled between the first antenna element 30 and the second antenna element 40 can comprise one or more inductances 50 coupled directly between the first antenna element 30 and the second antenna element 40 (as illustrated in FIG. 2B, 2C) or the one or more inductances 50 coupled between the first antenna element 30 and the second antenna element 40 can comprise a first inductance 60 connected between the first antenna element 30 and the first grounding element 38, a second inductance 60 connected between the second antenna element 40 and the second grounding element 48 and a further inductance connected between the first grounding element 38 and the second grounding element 48 (as illustrated in FIG. 4 &5)

FIG. 3 illustrates an example of any of the apparatus 10 as previously described. FIG. 3 illustrates an example of any of the apparatus 10 and comprises features as described with reference to FIG. 1, FIGS. 2A, 2B and 2C. The description of those FIGs is incorporated by reference.

FIGS. 4 and 5 illustrate an example of any of the apparatus 10 as previously described. In these examples, the first antenna element 30, the first capacitive feed element 36, the ground plane 100 and the first grounding element 38 lie in the plane 102. The second antenna element 40, the second capacitive feed element 46, the ground plane 100 and the second grounding element 48 also lie in the plane 102.

In these examples, as illustrated in FIG. 6, the first antenna element 30, the first capacitive feed element 36, the ground plane 100 and the first grounding element 38 are formed from a single layer of conductive material 302 supported by a dielectric substrate 304. The first antenna element 30, the first capacitive feed element 36 and the first grounding element 38 can be formed by removing conductive material 302 that covers the dielectric substrate 304. The second antenna element 40, the second capacitive feed element 46, the ground plane 100 and the second grounding element 48 are formed from the single layer of conductive material 302 supported by the dielectric substrate 304. The second antenna element 40, the second capacitive feed element 46 and the second grounding element 48 can be formed by removing conductive material 302 that covers the dielectric substrate 304.

A printed circuit board (PCB) 300, for example a single-sided PCB, can provide the conductive material 302 and the dielectric substrate 304. The PCB can, in some examples, be flexible.

In other examples, the antenna part is provided separately, for example on a flexi-foil which is then soldered to a normal “non-flexible” FR4 PCB which carries the electronic circuitry. The antenna part could be made in many ways including and not limited to: sheet metal, molded interconnect devices (MID), laser direct structuring (LDS), microwave suitable laminates and substrates, etc.

In FIGS. 4 and 5 the energy harvesting circuitry 140 extracts energy from the radio waves 2 (not illustrated) incident upon the second antenna element 40. The apparatus 10 is powered by energy harvesting performed by the energy harvesting circuitry 140. The backscatter modulation circuitry 130 modulates (varies with respect to time) backscattering of radio waves 2 (not illustrated) incident upon the first antenna element 30. The radio waves 2 are deliberately backscattered (reflected) using a backscattering impedance that has two different states Z1, Z2.

A single-pole single-throw (SPST) switch 132 is used to couple the first antenna element 30 to a first impedance Z1 or a second impedance Z2. The first impedance Z1 is predominantly capacitive (phase lag) and the second impedance Z2 is predominantly inductive (phase lead).

The first impedance Z1 and the second impedance Z2 can be configured such that the single-pole single-throw (SPST) switch enables binary phase shift keying.

The single-pole single-throw (SPST) switch is controlled by a modulation control circuit 150 powered by the energy harvesting circuitry 140.

Optionally the energy harvesting circuitry 140 provides energy to the backscatter modulation circuitry 130 in this example to the single-pole single-throw (SPST) switch 132.

In these examples, the energy harvesting circuitry 140 uses a radio frequency to DC power converter, for example rectifier circuitry 142. The rectifier circuitry 142 is configured to transform the time variable energy (AC) of the incident energy waves 2 (not illustrated) to a non time-varying energy (DC). The rectifier circuitry 142 comprises an electric current path to ground via a forward biased diode and a capacitor connected in series. The voltage across the capacitor provides the rectifier circuitry output.

In FIG. 4, the output of the rectifier circuitry 142 is provided to an energy store 144 for storage. The energy store 144 can, for example, be a large capacitor or supercapacitor. The energy store 144 provides energy to the modulation control circuitry 150 and to the backscatter modulation circuitry 130, if required. The apparatus 10 uses previously harvested energy, or if there is insufficient previously harvested energy it can use contemporaneously harvested energy.

In FIG. 5, the output of the rectifier circuitry 142 is not provided to an energy store for storage. The output of the rectifier circuitry 142 is provided to the modulation control circuitry 150 and to the backscatter modulation circuitry 130, if required. The apparatus 10 uses contemporaneously harvested energy.

In FIGS. 4 & 5, a separation between the first grounding element 38 and the second grounding element 48 near the ground plane 100 is greater than a separation between the first grounding element 38 and the second grounding element 48 near the first and second antenna elements 30, 40.

However, in other examples a separation between the first grounding element 38 and the second grounding element 48 near the ground plane 100 is the same as a separation between the first grounding element 38 and the second grounding element 48 near the first and second antenna elements 30, 40.

In this example, but not necessarily all examples, a separation gap between the first portion 31 of the first antenna element 30 and the first grounding element 38 is substantially the same as a separation gap between the first portion 41 of the second antenna element 40 and the second grounding element 48 and is substantially the same as a separation gap between the first grounding element 38 and the second grounding element 48.

An inductance 60, for example a lumped inductance, is connected across the separation gap between the first portion 31 of the first antenna element 30 and the first grounding element 40. A second inductance 60, for example a lumped inductance, is connected across the separation gap between the first portion 41 of the second antenna element 40 and the second grounding element 48. In some examples an isolating inductance 50, for example a lumped inductance, is connected across the separation gap between the first grounding element 38 and the second grounding element 48. Thus, there is an inductance between the first portion 31 of the first antenna element 30 and the first portion 41 of the second antenna element 40.

In some examples, a physical separation between the first portion 31 of the first antenna element 30 (the portion nearest the second antenna element 40) and the first portion 41 of the second antenna element 40 (the portion nearest the first antenna element 30) is less than a ¼ or ⅛^{th} of a wavelength of the first frequency.

This physical separation distance can be much smaller in terms of wavelength, for example as small as a couple of mm.

In the foregoing examples, certain aspects of design enable a compact apparatus with good operational characteristics. For example, the first antenna element 30 is distinct from but proximal to the second antenna element 40 at the respective first points 31, 41, however, the first feed 34 is distinct from and distal from the second feed 44.

As illustrated in FIGS. 4 & 5, and FIG. 6, the first antenna element 30 and the second antenna element 40 can be formed on the same side of a printed circuit board providing the first feed 34 and the second feed 44. In some examples, a maximum dimension of the PCB or of the portion of the PCB comprising the first antenna element 30 and the second antenna element 40 is less than one wavelength of the first frequency. In some examples, a maximum dimension of the PCB is 30 mm but this is dependent upon resonance frequency.

FIG. 6 Illustrates an example of any of the apparatus 10 as previously described. A printed circuit board (PCB) 300, for example a single-sided PCB, that provides conductive material 302 and a dielectric substrate 304. The PCB 300 can, in some examples, be flexible. In this example, the first antenna element 30, the first capacitive feed element 36, the ground plane 100 and the first grounding element 38 are formed from the single layer of conductive material 302 supported by the dielectric substrate 304. The second antenna element 40, the second capacitive feed element 46, the ground plane 100 and the second grounding element 48 are formed from the single layer of conductive material 302 supported by the dielectric substrate 304. The energy harvesting circuitry 140, the backscatter modulation circuitry 130 and any other circuitry are provided on the PCB.

If used, one or more electrical isolation elements 50 are connected to the PCB (not illustrated in this FIG). These can be one or more lumped components, for example lumped inductors.

If used, the first inductance 60 is provided as an inductor connected to the PCB and the second inductance 60 is provided as an inductor connected to the PCB (not illustrated in this FIG).

FIG. 7 illustrates a further example of backscatter modulation circuitry 130. This backscatter modulation circuitry 130 is configured to switch between multiple different impedance states Zi to vary backscatter reflection Ri over time.

The backscatter modulation circuitry 130 comprises a single pole N throw (SPNT) switch 132. The backscatter modulation circuitry 130 is configured to switch between N different impedance states using the single pole N throw switch 132.

The pole 134 of the SPNT switch 132 is coupled to the first antenna element 30 via the first feed 34. The pole 134 of the SPNT switch 132 is selectively coupled to one of the impedances Z1, Z2, Z3 . . . . ZN. The impedances Z1, Z2, Z3 . . . . ZN are complex impedances and at least some of them comprise a reactive (imaginary) component. Each respective impedance Zi causes a different reflection coefficient Ri and different backscattering.

The impedances can be selected to provide phase shift keying (with or without amplitude modulation). Phase shift keying is a modulation approach that uses defined points in phase space to represent different information. For example, binary phase shift keying uses two defined points in phase space. Maximum efficiency is achieved if the defined points have maximal separation.

The impedances can be selected to provide phase shift keying (different phase changes at reflection). In one example, the SPNT switch 132 is a single pole dual throw SPDT switch that provides binary phase shift keying (BPSK). This provides higher average power that on-off shift keying as on-off keying only backscatters during the on phase whereas BPSK backscatters in both phases. BPSK provides a modulation factor of 1 (the ratio of the change in the amplitude of the carrier wave to the amplitude of the original carrier wave). This increases coverage.

In some examples the apparatus 10 is an ambient internet of things (AIoT) device. An AIoT device is an ambient power-enabled Internet of Things device. It is an IoT device powered by energy harvesting, being either battery-less or with limited energy storage capability (e.g., using a capacitor or supercapacitor). An AIoT device of Class A is battery-less and uses contemporaneous energy harvesting for operation. An AIoT device of Class B is battery-less and can use contemporaneous energy harvesting and/or previously stored harvested energy for operation.

In some examples the apparatus 10 is a passive radio and backscatters only in response to reception of activation radio signals. In some examples the passive radio backscatters only activation radio signals. An activation radio signal can be addressed to a particular passive radio or to a particular group of passive radios.

In some examples, the apparatus is configured as a passive radio tag that can be attached to another object.

In some examples the apparatus 10 is an ambient passive radio that is an ambient power-enabled passive radio. An ambient power-enabled passive radio is a passive radio powered by energy harvesting. The apparatus 10 can, for example, be charged by an activation signal alone or charged not by activation signal alone.

In FIG. 8 the apparatus 10 is an ambient passive radio 210 and the received radio signals 2 comprise activation signals 204 of the ambient passive radio 210. The activation signals 204 are transmitted by an activator 200. The activation signals 204 are used for energy harvesting at the apparatus 10. The activation signals 204 are backscattered by the apparatus 10 as backscattered signals 4. The backscattered signals 4 are received by the reader apparatus 200. In this example, the activator apparatus 200 and the reader apparatus 202 are co-located, however in other examples they are not co-located.

In some examples, the activator apparatus 200 is a transmission-reception point (TRP), for example a base station, in a cellular telecommunications network. In some examples, the reader apparatus 202 is a transmission-reception point (TRP), for example a base station, in a cellular telecommunications network. In some examples, the activator apparatus 200 and the reader apparatus 202 are a transmission-reception point (TRP), for example a base station, in a cellular telecommunications network.

In some examples, an activator apparatus 200 can operate with one reader apparatus 202. In some examples, an activator apparatus 200 can operate with multiple reader apparatus 202.

In some examples, a reader apparatus 202 is a user equipment.

In some examples, an activator apparatus 200 is a user equipment.

In some examples, the isolation between the antenna port of the first antenna element 30 and the antenna port for the second antenna element 40 (the S-parameter S12 and S-parameter S21 is more negative than −15 dB or −20 dB).

The first frequency can be a single frequency or a narrow frequency band.

In this example, the first frequency can be 2.5 GHZ. However, other radio frequency bands can be used.

The S-parameter S11 and S-parameter S22 can have high Q-factors at the first frequency. In some examples, the efficiency (total radiated power compared to a lossless isotropic antenna) is less than −1 dB.

The inductors 60 are used to control the resonance frequency of the antenna elements 30, 40. In some examples, the inductors 60 each have a value of 12 nH.

The inductor 50 is used the control isolation. In some examples, it has a value less than the inductor 60. In some examples it has a value 4 nH.

The back-scattered phase can be changed 180° at the antenna port of the first antenna element 30 without affecting the impedance match of the antenna port for the second antenna element 40 used for RF energy harvesting/charging.

It will be appreciated that in the foregoing examples, the combination of the second antenna element 40 and energy harvesting circuitry 140 is configured to have a substantially constant, non-varied, impedance with no switching between impedance states. In at least some examples, the combination of the second antenna element and energy harvesting circuitry 140 is configured to be impedance matched for highest power transfer from radio frequency waves of the first frequency incident on the second antenna element 40.

It will be appreciated that in the foregoing examples (but not necessarily all examples), that the backscatter modulation circuitry 130 does not comprise any amplification circuitry.

It will be appreciated that in the foregoing examples (but not necessarily all examples), that the apparatus cannot independently transmit signals but can only backscatter signals.

The apparatus 10 uses two antennas. One for harvesting and one for backscattering. It does not time-divide use of an antenna between harvesting and backscattering. The apparatus can have continuously operable energy harvesting.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

Where a structural feature has been described, it may be replaced by means for performing one or more of the functions of the structural feature whether that function or those functions are explicitly or implicitly described.

In some but not necessarily all examples, the apparatus 10 is configured to communicate data from the apparatus 10 with or without local storage of the data in a memory at the apparatus 10 and with or without local processing of the data by circuitry or processors at the apparatus 10. The data may, for example, be measurement data, or data produced by the processing of measurement data. The data may be stored in processed or unprocessed format remotely at one or more devices. The data may be stored in the Cloud. The data may be processed remotely at one or more devices. The data may be partially processed locally and partially processed remotely at one or more devices. The data may be communicated to the remote devices wirelessly. The apparatus 10 may be part of the Internet of Things forming part of a larger, distributed network. The processing of the data, whether local or remote, may be for the purpose of health monitoring, data aggregation, patient monitoring, vital signs monitoring or other purposes. The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network. The processing of the data, whether local or remote, may produce an output. The output may be communicated to the apparatus 10 where it may produce an output sensible to the subject such as an audio output, visual output or haptic output.

The recording of data may comprise only temporary recording, or it may comprise permanent recording or it may comprise both temporary recording and permanent recording, Temporary recording implies the recording of data temporarily. This may, for example, occur during sensing or image capture, occur at a dynamic memory, occur at a buffer such as a circular buffer, a register, a cache or similar. Permanent recording implies that the data is in the form of an addressable data structure that is retrievable from an addressable memory space and can therefore be stored and retrieved until deleted or over-written, although long-term storage may or may not occur.

As used here ‘module’ refers to a unit or apparatus that excludes certain parts/components that would be added by an end manufacturer or a user. The apparatus 10 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example. Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1-15. (canceled)

16. An apparatus comprising:
energy harvesting circuitry;
backscatter modulation circuitry powered at least partially using energy provided by the energy harvesting circuitry;
a first antenna element coupled via a first feed to the backscatter modulation circuitry; and
a second antenna element coupled via a second feed to the energy harvesting circuitry,
wherein the apparatus is configured to receive radio signals simultaneously, at the same frequency, at the backscatter modulation circuitry via the first antenna element and at the energy harvesting circuitry via the second antenna element.

17. An apparatus as claimed in claim 16, wherein the backscatter modulation circuitry is configured to backscatter radio frequency waves of a first frequency incident on the first antenna and the energy harvesting circuitry is configured to harvest energy from radio frequency waves of the first frequency incident on the second antenna.

18. An apparatus as claimed in claim 16, wherein the backscatter modulation circuitry is configured to backscatter radio frequency waves of the first frequency incident on the first antenna simultaneously with energy harvesting from radio frequency waves of the first frequency incident on the second antenna by the energy harvesting circuitry.

19. An apparatus as claimed in claim 16, wherein the energy harvesting circuitry is configured to harvest energy from radio frequency waves of the first frequency incident on the second antenna simultaneously with backscatter of radio frequency waves of the first frequency incident on the first antenna by the backscatter modulation circuitry.

20. An apparatus as claimed in claim 16, wherein the backscatter modulation circuitry is configured to backscatter radio frequency waves incident on the first antenna but not the second antenna and the energy harvesting circuitry is configured to harvest energy from radio frequency waves incident on the second antenna but not the first antenna.

21. An apparatus as claimed in claim 16, wherein the first antenna element is distinct from the second antenna element and the first feed is distinct from the second feed.

22. An apparatus as claimed in claim 16, comprising one or more electrical isolation elements coupled between the first antenna element and the second antenna element.

23. An apparatus as claimed in claim 16, wherein the first feed is located adjacent a second portion of the first antenna element and the second feed is located adjacent a second portion of the second antenna element, wherein the second portion of the first antenna element and the second portion of the second antenna element are the most distant respective portions of the first antenna element and the second antenna element.

24. An apparatus as claimed in claim 16, wherein the first feed comprises a capacitive feed element separated from the second part of the first antenna element and wherein the second feed comprises a capacitive feed element separated from the second part of the second antenna element.

25. An apparatus as claimed in claim 16, wherein the first antenna element extends from a first part of the first antenna element to a second part of the first antenna element in a first direction within a first plane parallel to a ground plane and wherein the second antenna element extends from a first part of the second antenna element to a second part of the second antenna element in a second direction within a second plane parallel to the ground plane, wherein the first plane and the second plane are co-planar and the first direction and the second direction are opposing directions.

26. An apparatus as claimed in claim 16, wherein the first antenna element has a first length between the first part of the first antenna element and the second part of the first antenna element and the second antenna element has a second length between the first part of the second antenna element and the second part of the second antenna element wherein the first length and the second length are substantially the same.

27. An apparatus as claimed in claim 16, comprising a first grounding element separated from the first antenna element, a second grounding element separated from the second antenna element, a first inductance connected between the first grounding element and the first antenna element and a second inductance connected between the second grounding element and the second antenna element.

28. An apparatus as claimed in claim 16, wherein the first grounding element extends from a ground plane and the second grounding element extends from the ground plane.

29. An apparatus as claimed in claim 16, wherein the backscatter modulation circuitry is configured to switch between multiple different impedance states to vary backscatter reflection over time.

30. An apparatus as claimed in claim 16, comprising a single pole N throw switch, wherein the backscatter modulation circuitry is configured to switch between N different impedance states using the single pole N throw switch.

31. An apparatus as claimed in claim 16, wherein the backscatter circuitry is configured to provide binary phase shift keying.

32. An apparatus as claimed in claim 16, wherein the apparatus is a passive radio and the received radio signals comprise activation signals of the passive radio.

33. A method comprising
receiving radio signals simultaneously, at the same frequency, at a backscatter modulation circuitry via a first antenna element and at an energy harvesting circuitry via a second antenna element.

34. A method as claimed in claim 33, wherein the method further comprises:
backscattering, by the backscatter modulation circuitry, radio frequency waves of a first frequency incident on the first antenna simultaneously with energy harvesting from radio frequency waves of the first frequency incident on the second antenna by the energy harvesting circuitry.

35. A non-transitory computer readable medium comprising program instructions that, when executed by an apparatus, cause the apparatus to perform at least the following: receive radio signals simultaneously, at the same frequency, at a backscatter modulation circuitry via a first antenna element and at an energy harvesting circuitry via a second antenna element.
